(19) United States
(12) Patent Application Publication
(10) Pub. No.: US 2006/0154589 A1
(43) Pub. Date: Jul. 13, 2006

(54) High speed coin processing machine

(76) Inventor: Gregory F. String, Mechanicsburg, PA (US)

Correspondence Address: Jeffrey S. Habib, Esq.;Hooker & Habib, P.C., Suite 304, 100 Chestnut St., Harrisburg, PA, 17101, US

(21) Appl. No.: 11/032,718

(22) Filed: Jan. 11, 2005

(51) Int. Cl. G07D 3/00

(52) U.S. Cl. 453/11

(57) ABSTRACT

A coin processing machine for sorting or verifying coins includes a hopper for receiving and discharging coins, a processing device to one side of the hopper, and a feed device extending between the hopper and the processing device to drive coins discharged from the hopper to the processing device. The feed device has a belt drive that drives coins along the transfer plate. The processing device has a processing plate that defines a circular coin path, a wall extending along the coin path, and a rotating drive disk that drives coins along the coin path. The disk rotates concentrically with respect to the wall to reliably locate coins against the wall for sensing or processing.

### FIELD OF THE INVENTION

The invention relates generally to devices for processing mixed denominations of coins, that is, devices for sorting or verifying coins.

### BACKGROUND OF THE INVENTION

Banks and other business handle mixed denominations of coins. The coins must be sorted by denomination, and the sorted coins are wrapped or bundled for deposit or later use in cash registers or change machines.

Coin processing machines, such as coin sorters and coin verifiers, have been developed to mechanically process mixed denominations of coins. Coin sorters sort the coins. Coin verifiers verify that sorted coins are made up of only coins of a single denomination. Coin verifiers are often used prior to wrapping or bundling coins discharged from a coin sorter.

Coin processing machines include a hopper that receives the coins and a processing device that sorts or verifies coins. The hopper discharges a stream of coins to the processing device where the coins move on a plate defining a coin path. In one known coin sorter, the coin path has openings for respective diameter of coins. In one known coin verifier, the coin path has a single opening that enables only coins of the desired denomination to pass through the opening. Coins having a larger diameter, however, jam the machine and must be manually removed.

A known coin sorter disclosed in Adams et al. U.S. Pat. No. 5,525,104 (which patent is incorporated herein by reference) includes a hopper having a turntable or rotatable disk that receives the coins and throws the coins against a wall extending along the disk. The coins are discharged in single file and move along a circular coin path in the processing device. The circular hopper disk and circular coin path both reduce the space taken up by the coin sorter. The coins are driven along the coin path by a rotating drive disk. The drive disk overlaps the hopper disk to transfer the coins from the hopper to the processing device.

Although the known coin sorter operates well when new, overlapping of the rotating hopper and drive disks causes rapid wear of the hopper disk. The hopper disk must be replaced frequently, increasing cost and downtime. If replacement is delayed, coins discharged from the worn hopper disk are misaligned on the coin path and may be mis-sorted. The mis-sorted coins may later jam a coin verifier, causing additional downtime and expense.

Thus there is a need for an improved coin processing machine that reduces wear of the hopper disk. The coin processing machine should reliably sort or verify coins without misalignment of coins or jamming, and preferably should enable even higher processing speeds than conventional processing machines.

### SUMMARY OF THE INVENTION

The invention is directed to an improved coin processing machine that reduces wear of the hopper disk. The coin processing machine of the present invention reliably sorts or verify coins without misalignment or jamming, and enables even higher processing speeds than conventional processing machines.

A coin processing machine in accordance with the present invention includes a hopper for receiving and discharging coins, a processing device to one side of the hopper, and a feed device extending between the hopper and the processing device to drive coins discharged from the hopper to the processing device. The feed device includes a transfer plate configured to support coins discharged from the hopper and a drive for driving coins along the transfer plate. The drive has an endless belt configured to engage and urge coins along the transfer plate.

The processing device comprising a processing plate configured to support coins discharged from the transfer plate, the processing plate defining a curved processing track, and a disk rotatable with respect to the processing plate and facing the processing plate to drive coins along the processing track;

The disk overlaps a portion of the transfer plate to engage coins on the transfer plate and move the coins from the transfer plate to and along the processing track.

The processing machine of the present invention has a number of advantages. The disk does not overlap the hopper and wear caused by the overlap is eliminated. The belt preferably accelerates the coins received from the hopper, spacing the coins apart when received by the disk. The disk can further accelerate the coins transferred to the processing plate to further space the coins apart. This further increases processing speed and reliability.

In preferred embodiments of the present invention, the rotational axis of the disk is offset from the center of the processing track. A wall surrounds the periphery of the processing track. As the coins are driven along the track, the wall moves the coins towards the center of the disk, ensuring the coins are reliably positioned against the wall, further increasing operating reliability of the machine.

In one embodiment the processing device is a coin verifier that greatly reduces or eliminates jamming experienced using conventional coin verifiers. The verifier has three openings in the processing path. The first opening is upstream from the other two openings and removes coins whose diameter is smaller than the coin being verified. The second, next downstream opening, removes coins being verified. The third opening remains all remaining coins or material. Oversized coins or slugs do not jam the machine, enabling large amounts of coins to be quickly and reliably processed without downtime.

In preferred embodiments of the coin verifier sensors are placed between the first and second openings and between the second and third openings. Coins passing the first sensor increment a running coin count and coins passing the second sensor decrement the running count to maintain an accurate count of verified coins processed by the machine.

In another embodiment the processing machine is a coin sorter for sorting coins of mixed denominations. The sorter has a number of openings in the processing path. A sensor array upstream of the openings discriminates the diameter of the coins being sorted and provides a running count of each coin denomination. The sensor has no moving parts and does not require a complex imaging system.

Other objects and features of the present invention will become apparent as the description proceeds, especially when taken in conjunction with the accompanying drawing sheet illustrating three embodiments of the invention.

### BRIEF DESCRIPTION OF THE DRAWINGS

FIG. 1 is a top view of a first embodiment coin processing machine in accordance with the present invention;

FIG. 2 is an enlarged view of a portion of FIG. 1 illustrating the feed device used in the coin machine;

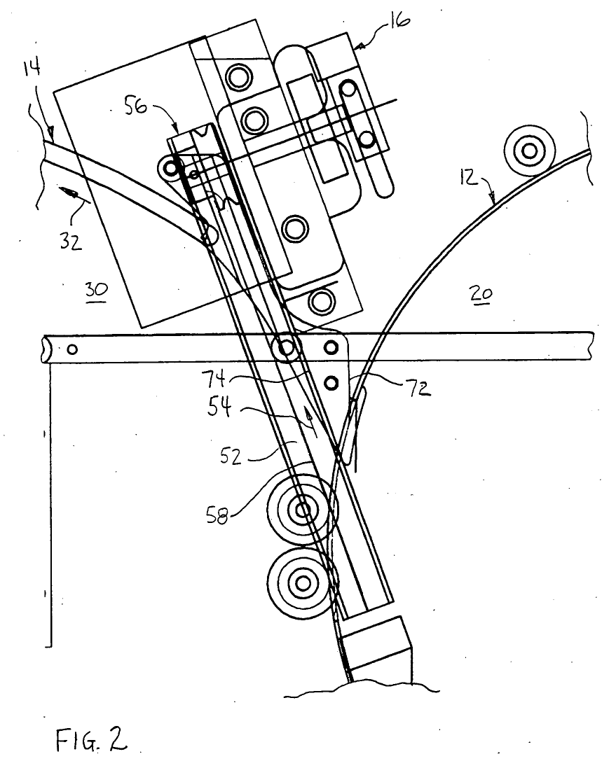

FIG. 3 is a side view of the feed device shown in FIG. 2;

FIG. 4 is an enlarged view of the processing device used in the coin machine shown in FIG. 1;

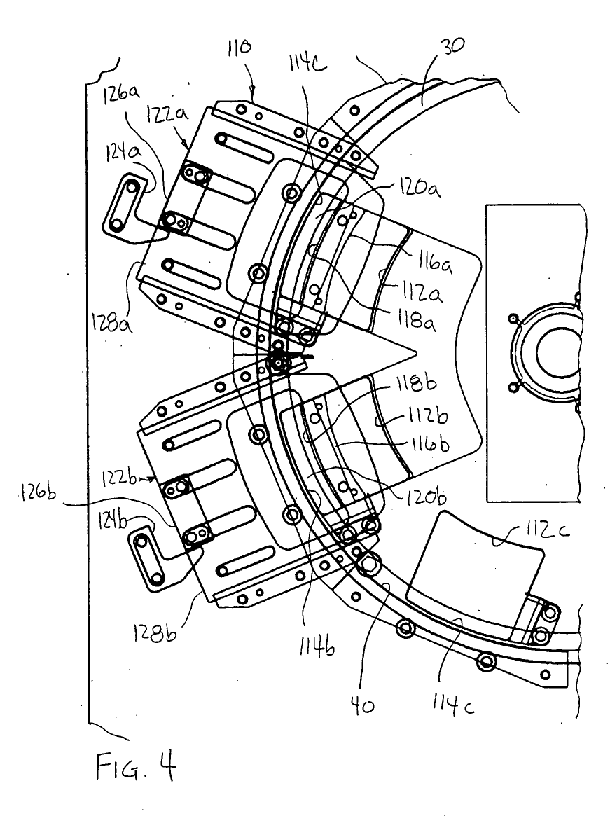

FIG. 5 is a top view of the processor plate used in the processing device shown in FIG. 4; and

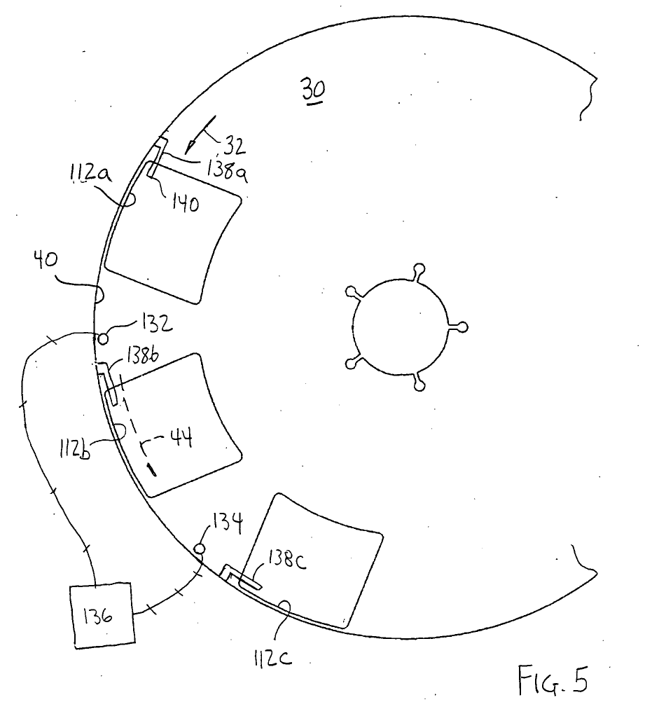

FIG. 6 is a partial top view of a second embodiment coin processing machine in accordance with the present invention.

### DESCRIPTION OF THE PREFERRED EMBODIMENT

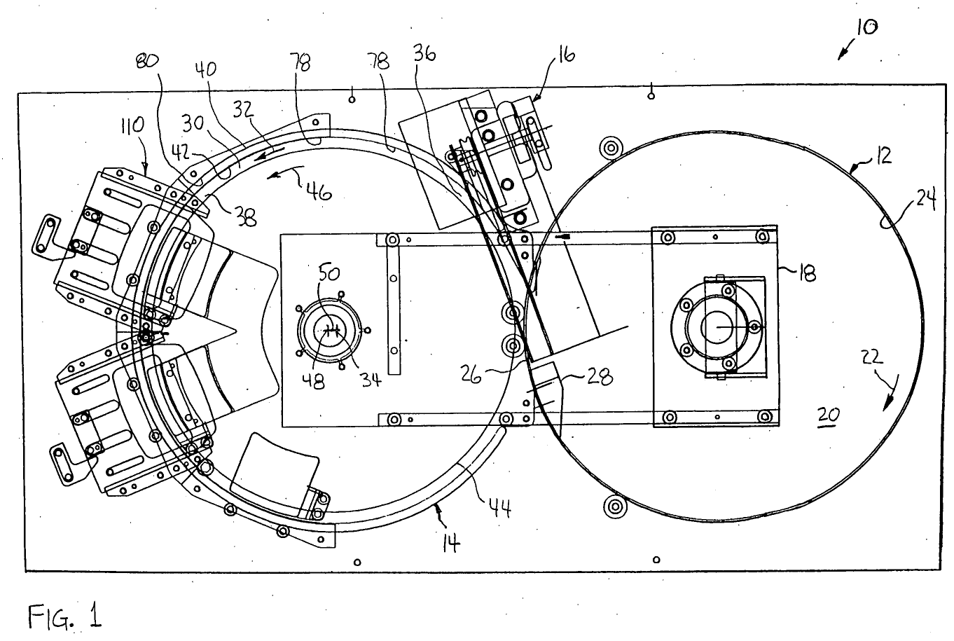

FIG. 1 illustrates a high-speed coin processing machine 10 in accordance with the present invention. The machine 10 includes a hopper 12 for receiving coins to be processed. The hopper 12 discharges a stream of coins for processing by a processing device 14. The illustrated processing device 14 verifies coins. A feed device 16 receives the coins discharged from the hopper 12 and transfers the coins to the processing device 14.

The hopper 12 has an inlet 18 that deposits coins on a turntable or rotatable disk 20 forming the floor of the hopper 12. The disk 20 is driven in the direction of arrow 22 by an electric motor (not shown). A stationary outer wall 24 extends along the outer periphery of the disk 20 to a discharge end 26 where coins are discharged from the hopper. Coins on the disk 20 are urged by centrifugal force against the wall 24 and move along the wall in the direction of disk rotation to the discharge end of the wall. A singulating plate 28 mounted on the wall 24 extends over the disk 20 at the hopper discharge. Plate 28 is spaced above the disk 20 by a distance less than twice the thickness of the thinnest coin to be processed (a dime if processing US currency). A single-layer stream of coins is discharged from the hopper 12 from beneath plate 28 in a direction substantially tangential to the disk 20.

Processing device 14 is located to one side of the hopper 12 and includes a stationary processing plate 30 that receives the stream of coins from the hopper 12. The upper, coin-supporting surfaces of the hopper disk 20 and the processing plate 30 are substantially co-planar. The processing plate 30 includes a circular coin path or processing path 32 that extends around a center of curvature 34. The coin path 32 extends downstream from an intake end 36 to a processing station 38 where the coins are processed. A wall 40 extends along the coin path 32 and has a circular inner abutment surface 42 that guides coins along the coin path. The wall 40 begins downstream of the intake end 36 and extends through the processing station 38.

A rotatable disk 44 is mounted above the processing plate 30. The outer periphery of the disk 44 is driven in the direction of arrow 46 by an electric motor (not shown) to drive the coins along the coin path 32. The disk 44 rotates about an axis of rotation 48 that is spaced from the center of curvature 34 away from the hopper 12 by an offset distance 50. There is clearance between the outer periphery of the disk 44 and the wall 40.

The underside of the disk 44 facing the plate 30 is spaced above the plate 30 with sufficient clearance to permit the thickest coin to be received under the disk. Spaced apart, flexible fingers (not shown) extend from the underside of the disk 44 above the coin path 32 to engage and drive the coins.

Feed device 16 includes a transfer plate 52 that extends between the hopper 12 and the processing device 14. The upper, coin-supporting surface of the transfer plate 52 is co-planar with the coin-supporting surfaces of the hopper disk 20 and the processing plate 30 and includes a coin path 54 that is substantially tangential to both the hopper disk 20 and the coin path 32. A feed drive 56 drives the coins discharged from the hopper 12 along the transfer plate and to the processing device 14.

In the illustrated embodiment the processing plate 30 and the transfer plate 54 are formed as a one-piece member. In other possible embodiments the plates 30, 54 can be individual, separate members.

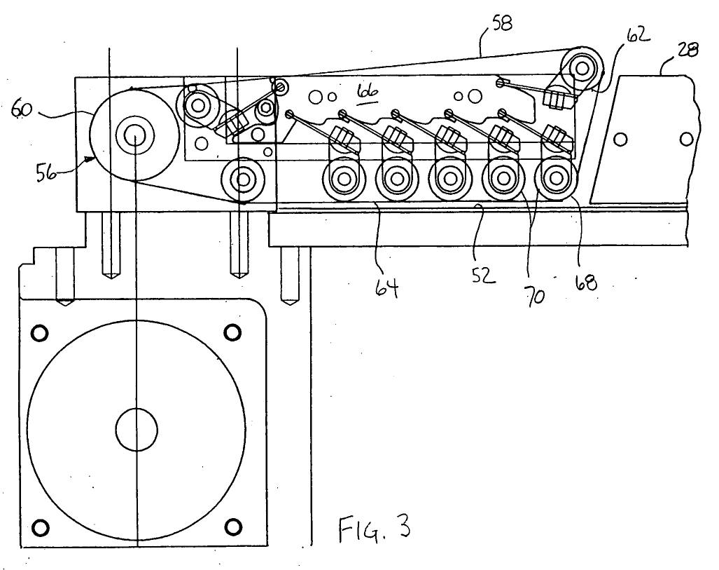

Feed drive 56 includes an endless flexible belt 58 that extends around a drive pulley 60 and a driven pulley 62 as best seen in FIG. 3. The belt 58 has a lower belt run 64 that is spaced above and extends along the coin path 52 and driven in the direction of coin path arrow 52. The driven pulley. 62 is spring-mounted on an elongate cantilever arm 66 that enables the belt run 64 to have an intake end 68 located above the hopper disk 20 and closely spaced from the singulating plate 28. Intermediate spring-mounted idler pulleys 70 attached to the arm 66 urge the lower belt run 64 against even thin coins spaced between thicker coins to reliably drive the coins along the transfer plate 52.

The belt run 64 is substantially centered over the coins discharged from the hopper 12. The width of the belt 58 is substantially less than the diameter of the smallest-diameter coin.

The disk 44 overlaps the transfer plate 58 to transfer coins from the feed device 16 to the processing device 14. The disk 44 is closely spaced from the lower belt run 64 to allow the disk 44 to overlap and engage the exposed portions of the coins not covered by the belt 58.

To assure proper alignment of the coins along the transfer path 54, feed drive 56 includes an alignment plate 72 mounted on the transfer plate 52 on the side of the belt 58 away from the processing device 14. The alignment plate 72 is spaced slightly above the transfer plate 58 and extends over the hopper disk 20 as shown. The plate 72 includes an elongate alignment surface 74 that extends along one side of the transfer path 54. The surface 74 abuts the stream of coins driven by the belt run 64 and preferably extends downstream slightly towards the belt run 64. The surface 74 assures proper alignment of the coins under the belt run 64 for takeaway by the disk 44 and assists in transferring the coins to the disk 44.

Operation of the feed device 16 in transferring coins from the hopper 12 to the processing device 14 is as follows. The hopper disk 20 is rotating at speed and discharges a stream of coins from beneath the singulating plate 28. The coins are touching each other and moving at essentially the speed v_{d} of the outer periphery of the disk 20.

The coins enter the belt intake end 68 and engage the lower belt run 64. Belt 58 is driven at a speed v_{b} greater than V_{d} so that the coins are accelerated as they engage and are driven by the belt. The acceleration spaces the coins apart as the belt receives and drives them along the coin path 54.

The flow of coins from the hopper 12 to the processing device 14 can be stopped, however, by stopping the belt 58 without the need of stopping hopper turntable 2o.

The belt run 64 is optimally positioned to engage coins that are against the hopper wall 24 as they are discharged from the hopper 12. Coins not against the wall 24 when discharged will engage the alignment plate 72 and are urged by the alignment surface 74 towards the belt run 44.

Coins moving along the transfer plate 52 enter the area of the transfer plate overlapped by the processor disk 44. The disk 44 engages the exposed portions of the coins not covered by the belt 58 and drives the coins away from the belt run 64 towards the intake end 36 of coin path 32. The processor disk 44 rotates at a speed that drives the coins at a speed vₚ preferably greater than v_{b} to smoothly transfer the spaced apart coins from the transfer plate 52 to the processing coin path 32. By further increasing the speed of the coins, the disk 44 further increases the spacing between coins entering the processor coin path 32.

The coins reach wall 40 and abut the inner wall surface 42 as the disk 44 drives the coins along the coin path 32. The distance from the wall surface 42 to the rotational axis 48 of the disk 44 decreases as the coins move along the wall towards the processing station 38. The decreasing distance occurs on account of the offset 50 of the disk axis 48 from the wall's center of curvature 34.

As the coins move along the wall 40 from wall surface portion 78 to downstream wall surface portion 80, the distance of the coins from rotational axis 48 decreases as described above. The coins are pressed firmly against the wall 40 as the wall 40 pushes and moves the coins inwardly with respect to the disk 44. This enables an optional coin sensing device located at a sensing station upstream of the processing station 38 to rely on the coins being reliably located against the wall 40 as they pass the sensing station.

The processing station 38 of the illustrated processing delivers coins to a coin verifier 110 intended to verify coins having a predetermined diameter (the “verified coin diameter”). The processor coin path 32 extends through the coin verifier 110 and the wall 40 also extends through the coin verifier to guide coins through the verifier.

Coin verifier 110 includes three circumferentially-spaced openings 112a, 112b, and 112c formed in the processor coin path 32. Each opening 112 extends through the thickness of the processing plate 30 and has a fixed, curved outer edge 114 that is spaced slightly inwardly from the wall 40. Carried in the openings 112a and 112b are movable members 116a, 116b that carry respective curved inner edges 118a, 118b facing an outer edge 114. The edges 114, 118 define respective coin slots 120a, 120b from the openings 112a, 112b. The upper surface of each member 116 is substantially co-planar with the upper surface of the processing plate 30.

The width of the slots 120a, 120b is established by respective calipers 122a, 122b. Each caliper 122 has a fixed caliper jaw 124 and a second, movable caliper jaw 126. Caliper jaw 126 is attached to and drives a lower plate 128 that extends beneath the processing plate 30 and positions the movable member 116 in the opening 120.

Closing each caliper 122 on a coin of the denomination being verified uses the coin as a template establishing the correct widths of slots 120a, 122b. Edge 118a is spaced away from the wall 40 a distance slightly less than the verified coin diameter, but not less than the diameter of the next smaller coin diameter (if any). Edge 118b is spaced away from the wall 40 a distance slightly greater than the verified coin diameter, but not greater than the diameter of the next larger coin diameter (if any). Plates 128 are fixed in position against the plate 30 by tightening setscrews 130 extending through elongate mounting slots in each plate 128.

Sensors 132 and 134 are located in the coin path 32 downstream from the first slot 120a. Sensor 132 is between the first slot 120a and the second slot 120b. Sensor 134 is between the second slot 120b and the opening 120c. The sensors 132, 134 are spaced from the wall 40 a distance less than the minimum coin diameter and each generates a signal indicating a coin has passed over it. Alternatively, the sensors 132, 134 can be mounted in the wall 40 and detect the edge of the coins in the coin path 32. A controller 136 receives the sensor signals to keep a running count of verified coins.

Three leaf springs 138a, 138b, and 138c are mounted along the wall 40 adjacent respective openings 112a, 112b, and 112c. Each leaf spring 138 extends to a free end 140 between the disk 44 and the wall 40 immediately upstream or over the respective slot opening 112. The free end 140 is normally spaced above the coin path 32 a distance less than the thickness of the thinnest coin.

Operation of the coin verifier 110 is described next. The coins moving along the coin path 32 first approach coin slot 120a. Each coin engages the free end of spring 138a, upwardly deflecting the spring and generating a spring force pressing the coin against the coin path. When the coin reaches coin slot 120a, the outer edge of the coin is supported on the portion of the path between the wall 40 and the slot edge 114a. The inner edge of a coin having a diameter at least equal to the verified coin diameter is supported on the slot member 116a. The coin is supported on the plate 30 along the entire length of the coin slot 120a and moves to the second slot 120b.

The outer edge of a coin having a diameter less than the verified coin diameter is not supported on the slot member 116a. Slot 120a has sufficient length for the coins to fall through the plate 30 and be removed from the stream of coins prior to reaching the slot 120b. The spring force generated by the leaf spring 138a assists in urging the coin into the slot even if the coin is held between two larger coins or adheres to the disk 44. In this way coins having diameters less than the verified coin diameter are removed from the stream of coins for storage or subsequent processing.

The remaining coins have diameters not less than the verified coin diameter. The coins approach the coin slot 120b. Coins having a diameter equal to the verified coin diameter fall through the coin slot 120b and are collected. Spring 138b assists in urging the coins into the slot. The coins of the denomination being verified are removed from the stream of coins for storage or subsequent processing, such as coin wrapping.

Coins having a diameter greater than the verified coin diameter pass over coin slot 120b and then pass over the sensor 134. The sensor generates a signal for each coin passing over the sensor. The controller 136 decrements by one the running count of verified coins in response to each signal received from the sensor 134. This corrects the count for the increment generated by the coin having previously passed the sensor 132. The controller 136 can drive a display indicating the accumulative value of the verified coins processed.

The remaining coins fall through the opening 112c, which is substantially larger than the diameter of the largest coin. This assures that no coins travel beyond the opening. Spring 138c assists in urging the coins into the opening.

It is contemplated that coins being processed for verification will typically include only a small number of incorrect coins. A large majority of coins will be supported on the coin member 114a and will fall through the coin opening 120a. As a result, it is likely that member 114a will wear much faster than member 114b. By making members 114a, 114b interchangeable, the members 114 can be periodically switched for even wear on both members.

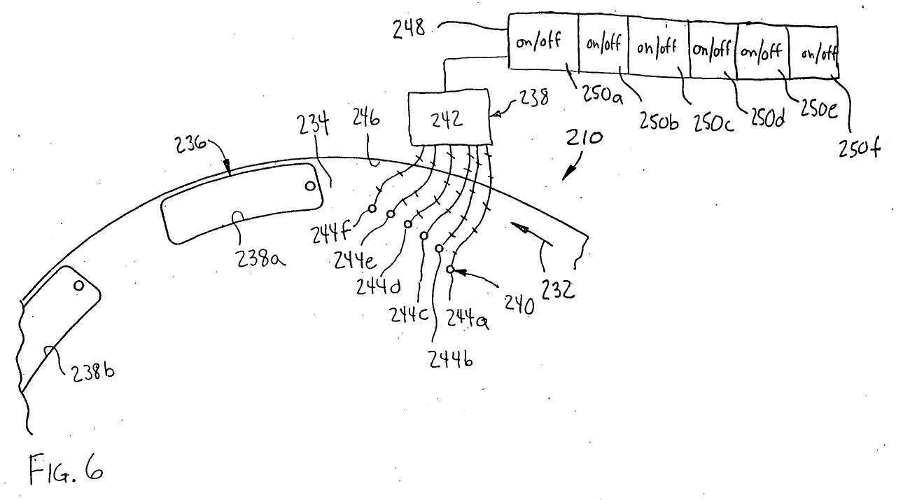

FIG. 6 illustrates a portion of a second embodiment coin receiving and processing device 210 in accordance with the present invention. Device 210 is similar to the device 10 but sorts coins by denomination rather than verifying them.

The device 210 includes a hopper and feed device (not shown) like the hopper 12 that supplies a stream of coins to a coin path 232 like the coin path 32. The coins are driven along the coin path 232 by a drive disk (also not shown) like the drive disk 44. The processor coin path 232 extends to a processing station 234 where a conventional coin sorter 236 having a number of progressively wider through-slots 238 in the coin pathway 232 receives the coins.

Upstream of the processing station 236 is a coin discrimination device 238 that determines by coin diameter the denominations of coins passing on the coin pathway. The discrimination device 238 includes a sensor array 240 that generates signals and a controller 242 connected to the sensor array to receive and act upon the signals. The controller 242 generates an output signal representing the diameter of the coin for each coin that passes over the sensor array.

The sensor array 240 is made of a number of sensors 244 imbedded in the pathway 232. The sensors 244 are longitudinally spaced apart along the pathway 232 to sense respective locations along the pathway. Each sensor 24 is also spaced transversely away from a wall 246 like the wall 40.

The illustrated sensors 244a-f are arranged for discriminating the diameter of US currency and are associated with the half-dollar, the dollar, the quarter, the nickel, the penny, and the dime respectively. Each sensor 244 is associated with a respective coin diameter and a respective sensor location. The sensor location 244a associated with the largest coin diameter is upstream of the other sensor locations and each successive downstream sensor location 244b, . . . , 244f is associated with the next smaller coin diameter.

Each sensor location 244 is spaced from the wall 246 by a distance less than the diameter of the coin associated with the location but greater than the diameter of the next-smaller coin diameter, if any.

As previously described, the outer edges of the coins are reliably positioned against the wall 246 as they pass over the sensors 244. This aligns the inner edges of the coins along a longitudinal axis of the pathway. Each sensor 244 is covered by and can sense only coins having diameters not less than the coin diameter associated with the sensor as the coins move past the sensor array 240 to the processing station.

The inner edge or inner portion of each coin first covers the sensor 244 associated with the denomination of the coin, and successively covers downstream sensors, if any. The sensors 244 covered by the coin sequentially each transmit a respective signal to the controller 242 indicating that the sensor has been covered by the coin.

The controller 242 maintains an internal array 248 representing the sensor state 250a-250f of each sensor 244a-244f. The array 248 enables the controller to generate the appropriate output signal in response to a coin covering the sensor corresponding to the coin diameter. Each sensor state is initially “on”. The controller 242 generates an output signal only in response to receiving a signal from a sensor 244 whose corresponding sensor state 250 is “on”.

As a coin passes over the sensor array 240, the controller 242 receives a signal from the first sensor covered by the coin. The controller checks the state array 248 and determines whether the corresponding sensor state 250 is “on”. If so, the controller generates an output signal representative of the denomination of the sensor sending the signal and turns the downstream sensor states to “off”.

As the coin passes over each successive downstream sensor 244, sensor, the controller receives a signal from the sensor and determines that the corresponding sensor state is now “off”. The controller does not generate an output signal, but turns the corresponding sensor state back to “on”.

For an example of operation of the sensor device 238, assume a US quarter passes over the sensor array 240. The quarter causes sensor 244c to transmit a first signal to the controller 242 indicating that sensor 244c was covered by the coin. The controller 242 generates an output signal representing the quarter, and turns the sensor states 250d-250f corresponding to sensors 244d-244f to “off”. As the quarter passes over each of the downstream sensors 244d, 244e, and 244f, the controller does not generate an output signal in response to the signals generated by the downstream sensors but turns the corresponding sensor states back to “on” in preparation for sensing the next coin.

Preferably the coins are spaced apart along the pathway 232 a distance greater than the length of the sensor array 240 so that only one coin is passing over the sensor array at a time. If coins are touching the upstream coin might cover a sensor before the downstream coin clears the array. However, the controller 242 can still determine the denominations of the coins even if coins that are touching pass through the sensor array 240 because the upstream coin would always first cover a sensor whose corresponding sensor state is “on”.

The sensor array 240 can be mounted on a standardized, removable plate that mounts in a slot in the processing plate for ready adaption of the sensing device 238 to different sets of currency.

The illustrated embodiments illustrate use of the belt drive to transfer coins along a “figure 8” path in which the hopper plate 20 and the processing disk 44 rotate in opposite directions. The belt drive can be readily adapted for use in coin processing machines in which the hopper plate and the processing disk rotate in the same direction, such as the coin sorter disclosed in Rumbach, U.S. Pat. No. 5,551,911 (which patent is also incorporated by reference herein).

While I have illustrated and described a preferred embodiment of my invention, it is understood that this is capable of modification, and I therefore do not wish to be limited to the precise details set forth, but desire to avail myself of such changes and alterations as fall within the purview of the following claims.

What I claim as my invention is:

1. A coin receiving and processing device comprising:
a hopper for receiving coins and discharging a stream of coins to be processed, a processing device to one side of the hopper, and a feed device extending between the hopper and the processing device to drive coins discharged from the hopper to the processing device;
the feed device comprising a transfer plate configured to support coins discharged from the hopper and a drive for driving coins along the plate, the drive comprising an endless belt configured to engage and urge coins along the plate; and
the processing device comprising a processing plate configured to support coins discharged from the transfer plate, the processing plate defining a curved coin path, and a disk rotatable with respect to the processing plate and facing the processing plate to drive coins along the coin path;
the disk overlapping a portion of the transfer plate to engage coins on the transfer plate and move the coins from the transfer plate to and along the coin path.

2. The coin receiving and processing device of claim 1 wherein the belt comprises an intake end and a discharge end, and the disk is configured to engage coins on the transfer plate prior to the coins reaching the discharge end of the belt.

3. The coin receiving and processing device of claim 1 wherein the feed device comprises an alignment plate configured to abut coins driven along the transfer plate.

4. The coin receiving and processing device of claim 1 comprising an abutment surface extending along the coin path and the disk rotates non-concentrically with respect to the abutment surface.

5. The coin receiving and processing device of claim 1 wherein the hopper discharges coins at a first speed and the belt drives coins at a second, higher speed.

6. The coin receiving and processing device of claim 1 wherein the belt drives coins at a first speed and the disk drives coins at a second, higher speed.

7. The coin receiving and processing device of claim 1 wherein the processing device comprises one of: means for sorting coins and means for verifying coins.

8. A coin processing device for processing a stream of coins, the coin processing device comprising:
a processor plate comprising a curved processing track, the processing track comprising an outer periphery;
a disk facing the processing plate and rotatable about an axis with respect to the processing plate to drive coins in a downstream direction along the processing plate, the disk arranged to receive a stream of coins at an intake end of the processing track and at an intake distance from the axis;
a wall extending around at least a portion of the periphery, the wall comprising an abutment surface downstream from the intake end of the processing track and extending downstream along the track to guide coins driven along the processing track;
the abutment surface extending from a first surface portion to a second surface portion downstream from the first surface, the first surface portion a first distance from the axis not greater than the intake distance, and the second surface portion a second distance from the axis, the second distance less than the first distance whereby the wall exerts a force on the coins driven along the wall urging the coins radially inwardly with respect to the disk as the coins are driven along the abutment surface.

9. The coin processing device of claim 8 wherein the axis represents a first axis and the abutment surface has a constant radius of curvature defining a second axis, the first axis spaced from the second axis.

10. The coin processing device of claim 8 wherein the abutment surface has a variable radius of curvature.

11. The coin processing device of claim 8 wherein the disk comprises a plurality of fingers extending to free ends, the fingers adapted to engage coins on the processing track, and the fingers are spaced away from the abutment surface and do not engage the abutment surface.

12. The coin processing device of claim 11 comprising a spring having a free end disposed between the wall and the disk, the end of the spring normally spaced from the processing plate a distance less than the thinnest coin to be processed, whereby a coin passing the spring deflects the spring and generates a spring force urging the spring against the coin.

13. A coin verifier for verifying a single coin denomination of a currency having coin denominations with respective coin diameters, a verified coin diameter representing the diameter of the coin denomination being verified, the coin verifier comprising:
a plate comprising a coin pathway for flowing a singulated stream of coins along the pathway in a downstream direction;
first, second, and third slots in the pathway, the second slot downstream from the first slot and the third slot downstream from the second slot, each slot extending through the thickness of the plate;
the first slot having a width less than than the verified coin diameter whereby coins or slugs having a diameter less than the verified coin diameter fall through the first slot and are removed from the stream prior to reaching the second slot;
the second slot having a width greater than the verified coin diameter but less than the diameter of next larger coin diameter whereby coins having a diameter equal to the verified coin diameter fall through the second slot prior to reaching the third slot; and
the third slot having a width greater than the maximum coin diameter of the currency whereby coins having a diameter greater than the verified coin diameter fall through the third slot after passing over the second slot.

14. The coin verifier of claim 13 comprising a first sensor, a second sensor, and a counter operatively connected to the first and second sensors;
the first sensor configured to sense each coin flowing between the first slot and the second slot and generate a signal in response thereto;
the second sensor configured to sense each coin flowing between the second slot and the third slot and generate a signal in response thereto;
the counter comprising means for storing a running count of verified coins, the running count being incremented in response to each signal generated by the first sensor and being decremented in response to each signal generated by the second sensor.

15. The coin verifier of claim 13 wherein one or both of the first and second slots comprise a fixed edge and an adjustable edge, the adjustable edge movable with respect to the plate for adjusting the width of the slot.

16. The coin verifier of claim 15 wherein each adjustable edge is connected to a caliper whereby a coin can be used as a template to set the position of the edge.
